(19) United States
(12) Patent Application Publication
(10) Pub. No.: US 2024/0070716 A1
(43) Pub. Date: Feb. 29, 2024

(54) SYSTEMS AND METHODS FOR CONDITIONAL ADVERTISING BUDGET CALIBRATION AND ALLOCATION

(71) Applicant: Natural Concepts Marketing Group, DBA Ad Leverage, Thousand Oaks, CA (US)

(72) Inventors: Andrew Palosi, Thousand Oaks, CA (US); Vijay Singh, Reseda, CA (US); Brianna Skiffington, Winter Garden, FL (US)

(21) Appl. No.: 17/665,038

(22) Filed: Feb. 4, 2022

Related U.S. Application Data
(60) Provisional application No. 63/296,036, filed on Jan. 3, 2022.

(51) Int. Cl. G06Q 30/02

(52) U.S. Cl. CPC G06Q 30/0249

(57) ABSTRACT

A system for conditional advertising budget calibration and allocation is disclosed, including at least one user computing device in operable connection with a network. An application server is in operable communication with the user network to host an application program for providing a system for advertising budget calibration and allocation. The application program includes a user interface module for providing access to the application program through the user computing device. A machine learning engine receives a plurality data from an employee and capacity database configured to store employee capacity information and determining a bandwidth for one or more employees to allocate a budget. The system allows for the calibration of a daily budget to fill a capacity as well as allowing for the allocation of budgets between channels.

### CROSS-REFERENCE TO RELATED APPLICATIONS

The present application claims priority to U.S. Provisional Patent Application No. 63/296,036 filed Jan. 3, 2022, entitled “SYSTEMS AND METHODS FOR CONDITIONAL ADVERTISING BUDGET CALIBRATION AND ALLOCATION,” which is hereby incorporated by reference in its entirety.

### TECHNICAL FIELD

The embodiments generally relate to computerized systems and methods for asset calibration and allocation.

### BACKGROUND

Many businesses seek to generate high-quality leads during business development practices. Marketing teams employ various tactics to effectively market their goods and/or services to prospective buyers. However, many business use conventional marketing strategies developed before the advent of computerized marketing, sales force automation systems, customer relationship management systems, and computerized inventory analysis.

Web scraping may determine if inventory is available or out of stock in order to pause or enable advertisements. This helps to ensure that advertising budgets are used only for products that the consumer is able to purchase at that time. These systems often operate using a simple script to crawl a website to determine if the product is in stock or out of stock and then taking subsequent action of pausing or enabling the corresponding advertisement.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for conditional advertising budget calibration and allocation is disclosed, including at least one user computing device in operable connection with a network. An application server is in operable communication with the user network to host an application program for providing a system for advertising budget calibration and allocation. The application program includes a user interface module for providing access to the application program through the user computing device. A machine learning engine receives a plurality data from an employee and capacity database configured to store employee capacity information and determining a bandwidth for one or more employees to allocate a budget. The system allows for the calibration of a daily budget to fill a capacity as well as allowing for the allocation of budgets between channels.

The embodiments calibrate advertising budgets more effectively to fill pipelines when low and eliminate advertisements budget waste when the capacity of the salesperson is full, or when inefficiencies may be present. The platform uses defined parameters (provided either by human input or machine learning) by which budget calibration and allocation and/or subsequent bidding and/or subsequent statuses can adjust within. This allows the system to self-optimize toward an advertiser's goals of Return On Advertising Spend (ROAS) or opportunities, and/or save money when not advertising is not needed or is inefficient or certain goods and/or services or based on personnel bandwidth. The system may self-optimize toward an advertiser's goals, and to provide an efficient means for allocating budget towards the salesperson or products based on availability of each. The system may aid an individual or business in saving money spent on advertising when not needed, as in, if the salesperson has no bandwidth (i.e., are fully scheduled or have other responsibilities over the next x-number of days, or if a product is out of stock).

The system solves various problems and shortcomings in the current arts by aiding in the spending advertising budgets more effectively while remaining in-tune with client's real-time business needs. Further, the system allows for multiple adjustable objectives. The system eliminates the need for manually paced digital budgets, whether based on slacks or text messages, in a ledger, or based on a moving target.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program and databases, according to some embodiments;

FIG. 4 illustrates a flowchart of a process for the calibration and allocation of advertising budgets;

FIG. 5 illustrates a screenshot of the actions interface, according to some embodiments;

FIG. 6 illustrates a screenshot of the accounts interface, according to some embodiments;

FIG. 7 illustrates a screenshot of the segments interface, according to some embodiments;

FIG. 8 illustrates a screenshot of the objectives interface, according to some embodiments;

FIG. 9 illustrates a screenshot of the campaigns interface, according to some embodiments;

FIG. 10 illustrates a screenshot of the budgets interface, according to some embodiments;

FIG. 11 illustrates a screenshot of the capacity interface, according to some embodiments; and

FIG. 12 illustrates a screenshot of the rules interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to systems and methods for conditional advertising budget calibration and allocation. The embodiments calibrate advertising budgets more effectively to fill pipelines when low and eliminate advertisements budget waste when the capacity of the salesperson is full, or when inefficiencies may be present. The platform uses defined parameters (provided either by human input or machine learning) by which budget calibration and allocation and/or subsequent bidding and/or subsequent statuses can adjust within. This allows the system to self-optimize toward an advertiser's goals of Return on Advertising Spend (ROAS) or opportunities, and/or save money when not advertising is not needed or is inefficient or certain goods and/or services or based on personnel bandwidth. The system may self-optimize toward an advertiser's goals, and to provide an efficient means for allocating budget towards the salesperson or products based on availability of each. The system may aid an individual or business in saving money spent on advertising when not needed, as in, if the salesperson have no bandwidth (i.e., are fully scheduled or have other responsibilities over the next x-number of days, or if a product is out of stock). In such, there can still be a maximum budget if needed, but the budget it can be used more effectively to eliminate both wasted advertisement dollars when capacity is full or wasted time when available capacity goes unfilled. In turn, using advertisement dollars can be used to optimize toward increased utilization rate. Additionally, the advertiser is able to choose their goals, and the system will allocate budgets between advertising channels automatically in order to meet them. For example, if the goal is Leads and Google Ads is generating a lower cost per lead than Bing Ads, the system will shift budget toward Google Ads in a controlled state, to move towards their goals and maximize their budget.

The prior existing technology is limited to on/off rules based on public URLs, if, for example, “out of stock” is found for a product, for example, the prior systems turn the advertisement campaign to OFF. In such, there is no comparable functionality for inventory rules when it comes to time or capacity as a measure of availability inventory or increasing or decreasing budget to calibrate effectively rather than only turning off or on advertisements.

Existing technology is limited to performing similar functions for ecommerce web based applications wherein inventory is publicly available. The limitation is, it is only capable of determining if inventory is available or out of stock and pausing or enabling advertisements. In the present embodiments described herein, the system is applying a similar concept but adding the dimensions of client relationship management (CRM) and context of goals. For example, opposed to inventory of products being in or out of stock and a simple script to crawl a website to find if the URL of an advertisement shows in stock or out of stock and take subsequent action of pausing or enabling ads. The embodiments provide the utility of taking an “inventory” of staffing (e.g., the bandwidth and availability of the salesperson), who does or does not have bandwidth to support additional opportunities, in the context of the preestablished goal.

As used herein, the term “goal” may be a user defined goal for advertisements and personnel bandwidth. A goal may be statistically determined for optimal goals based on machine learning and/or artificial intelligence engines to determine points of diminishing returns or maximum bandwidth before suffering cancellations. In some embodiments, the automated marketing will operate within the defined budget thresholds to operate more efficiently. In some embodiments, thresholds could be removed altogether to give autonomy and scale only limited by capacity which would grow dynamically with service capacity rather than constrained by defined budgets to only automatically be more efficient, instead also becoming automatically scalable.

As used herein, the term “budget” may refer to the threshold of resources which can be expended. Resources may relate to personnel resources (e.g., availability of marketing and sales personnel) as well as a monetary budget. For example, the budget may relate to the availability of a salesperson for a meeting, in reference to the salespersons preexisting meeting schedule.

In some embodiments, the system allows for the integration of advertisement platforms with one or more client relationship management systems. This may allow the system to analyze availability, productivity, and other metrics associated with the salesperson to efficiently allocate budgets to various products and/or personnel. The system may also quantify scheduling capacity and/or sales pipeline capacity using defined bandwidth goals. Rules may be established to optimize budget in correspondence with the bandwidth goals and sales pipeline capacity such that budget is increased or decreased efficiently and effectively. In such, the system aids in minimizing cancelations and maximize total available budget to meet goal parameters.

In some embodiments, the system may segment one or more aspects of a business to facilitate reaching preestablished goals at a granular level, such as by geographical area or service type.

As used herein, the term “user” may refer to any user in communication with the system including which is employed by or otherwise associated with the business, marketing agencies, sales personnel, etc.

The system is operable to perform acquire marketing data, sales data, personnel data, and the like in order to efficiently and effectively determine where to allocate budgets.

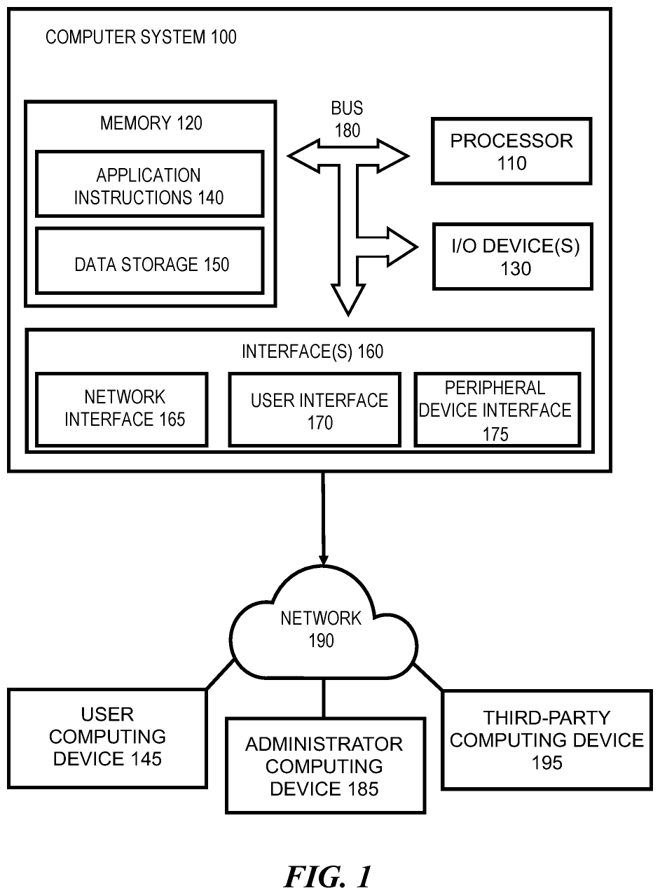

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by any user associated with the business to allow the user to establish goals, establish budget parameters (e.g., threshold values for the salesperson's bandwidth). The administrator computing device 185 may include users having administrative functions, or by managers and/or executives of the enterprise. The third-party computing device 195 may be utilized by third parties to receive communications from the user computing device and/or administrative computing device 185, to transmit communications to the user via the network, and otherwise interact with the various functionalities of the system. In one example, the third-party computing device may be in communication with a CRM system.

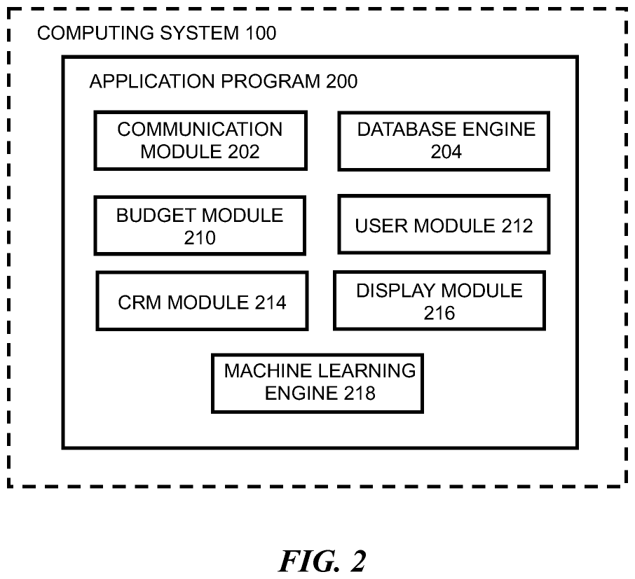

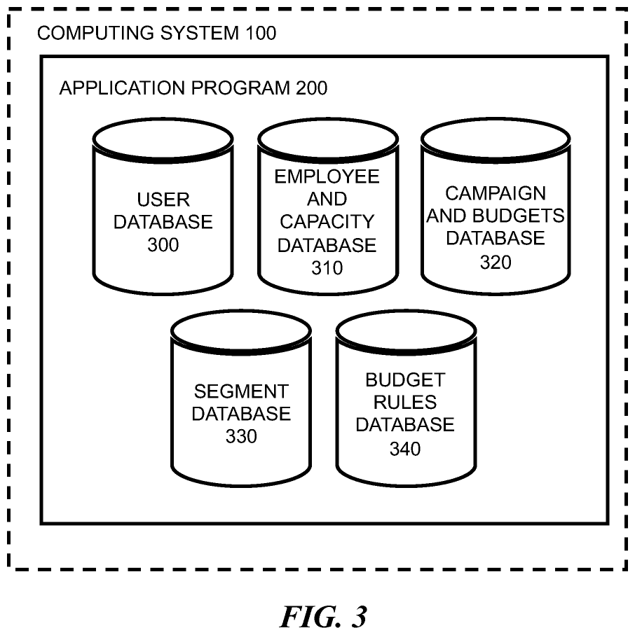

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a budget module 210, a user module 212, a CRM module 214, a display module 216, and a machine learning engine 218.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the budget module 210 allows the user to establish a budget which the system may allocate and calibrate based on various parameters including salesperson bandwidth (i.e., availability based on scheduling information). The budget module may be in communication with the machine learning engine 218 to automatically establish a budget and/or goals. The budget module 210 may receive marketing data, product data, salesperson metrics, and other information related to an enterprise's marketing campaigns, strategies, personnel availability, etc. The budget module 210 may be in operable communication with the machine learning engine 128 to autonomously or semi-autonomously determine and recommend more allocation and calibration of a budget such that the ROAS and opportunities are increased.

In some embodiments, the budget module 210 may calibrate based on capacity of the salesperson via a pre-established set of rules or artificial intelligence. The budget module allows the system to spend less advertising budget when the salesperson's capacity is full and spend more when the salesperson's capacity is not full. The budget module 210 may enact the rule set automatically, in such autonomously or semi-autonomously managing the advertising budget allocation and calibration.

In some embodiments, the budget module 210 may allocate by channel or campaigns based on goals established by the user or group of users. In one example, goal options can be more opportunity volume, or more revenue such as to allocate advertising budget away from low performing salespersons and provide higher performing salespersons with additional budget while ensuring the additional budget is allocate to salespeople who have adequate bandwidth.

In some embodiments, the user module 212 facilitates the creation of a user account for the application system. The user module 212 may allow the user to create user preferences, establish user credentials, set user goals related to the enterprise, define the user's role within the enterprise, etc. The user module 212 may determine the role of the user based on their credentials, such as by defining which department or sector the user operates in within the enterprise (e.g., sales, marketing, management, etc.).

In some embodiments, the CRM module 214 is configured to receive information stored in a CRM database associated with a CRM system utilized by the business or individual. The CRM module 214 allows for various data (e.g., salesperson availability, efficiency, etc.) to be provider to the machine learning engine 218 to establish goals and budgets.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 may be in communication with the augmented reality module 214 to display the video feed in real time.

In some embodiments, the display module may be in communication with an augmented reality (AR), virtual reality (VR), and/or mixed reality engines to provide the user with a display of the various functionalities described herein.

In some embodiments, the machine learning engine 218 may receive various data including salesperson data, product data, sales cycle metrics, marketing data, KPI information (including sales KPI's and marketing KPI's), and the like. Sales and marketing KPI's may include total sales, sales opportunities, closed opportunities, closed average sales, close rate, ROAS, advertising budget, etc.

FIG. 3 illustrates the computing system 100 in operable communication with the application program 200 having a plurality of databases in communication thereto. A user database 300 is operable to store user information such as user preferences, user profile information, historical usage data, historical content, communications information, etc. The user database 300 may store individual user metrics (e.g., user scheduling, scheduling preferences, availability, etc.). The employee and capacity database 310 stores employee information including employee (i.e., the salesperson) information and availability. This allows the system to calibrate and allocate a budget for each employee based on their available capacity. The campaign and budgets database 320 stores campaign and budget metrics including user-established budget and campaign goals as well as those established by the machine learning engine 218. The segments database 330 stores business segment information to allow for businesses to assess their budget and goals for each segment of the business. The budget rules database 340 stores budget rules input by the user or other employee of the business to allow the budget rules to be analyzed by the machine learning engine.

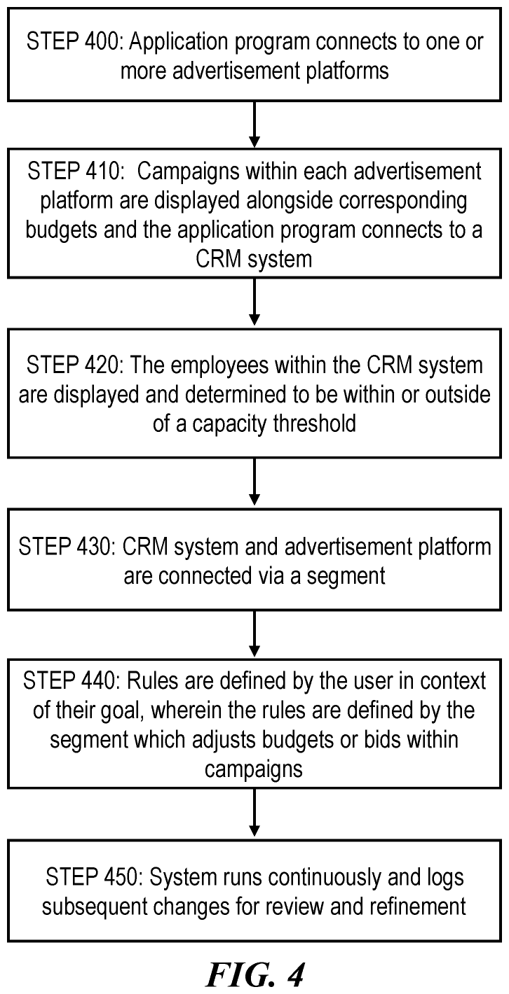

FIG. 4 illustrates a flowchart of a process for the conditional calibration and allocation of advertising budgets. In step 400 the application program connects to one or more advertisement platforms. In step 410, the advertisement campaigns within each advertisement platform are displayed alongside corresponding budgets and the application program connects to the CRM system. In step 420, the employees within the CRM system are displayed and determined to be within or outside of a capacity threshold. The capacity threshold may be defined in the application but sourced from the CRM system, such as scheduled working time & job hours booked to determine capacity remaining in context of the 100% capacity utilization goal, or opportunities assigned vs goal opportunities in context of the 100% capacity utilization goal. In step 430, the CRM system and advertisement platform are connected via a segment of the business. In step 440, the rules are defined by the user in context of the user-defined goal. In step 450, the system runs continuously and logs subsequent changes for review and refinement.

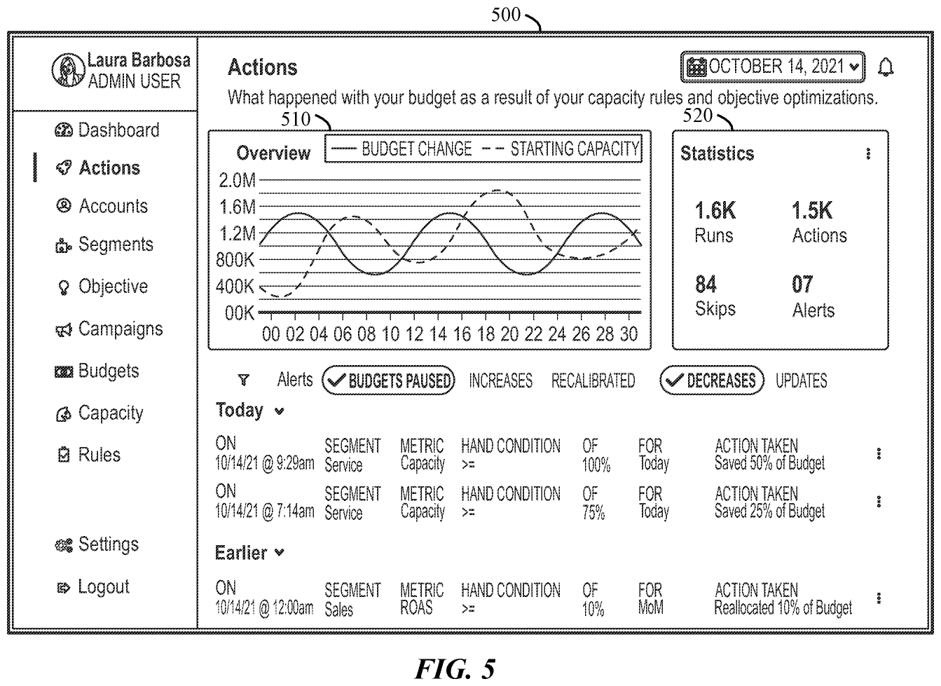

FIG. 5 illustrates a screenshot of the actions interface 500 provided by the display module wherein the user's dashboard of action tabs is provided including the functionalities provided in FIGS. 5-12 herein. The actions interface 500 includes an overview portion 510 wherein the overview of budget, budget change, and budget capacity is graphically illustrated over a time period. The actions interface 500 further includes a statistics portion 520 including statistics such as number of runs, actions, skips, alerts, etc. The actions interface 500 further includes alerts, budgets paused, increases, recalibrated, decreases, updates, and other information displayed to the user. Budget automation will be established by analyzing capacity and objectives for each client.

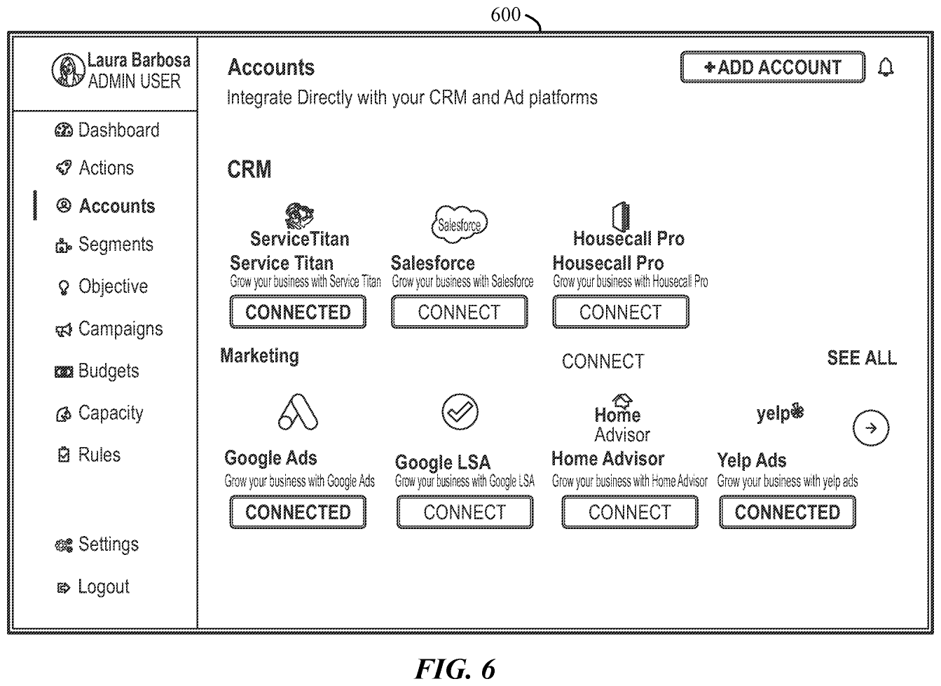

FIG. 6 illustrates a screenshot of the accounts interface 600 including a CRM portion 610 wherein the user is communicating with a CRM interface (e.g., a third party). For example, the user may interact with sales and marketing platforms, social media platforms, and other platforms which may aid in budget calibration and allocation.

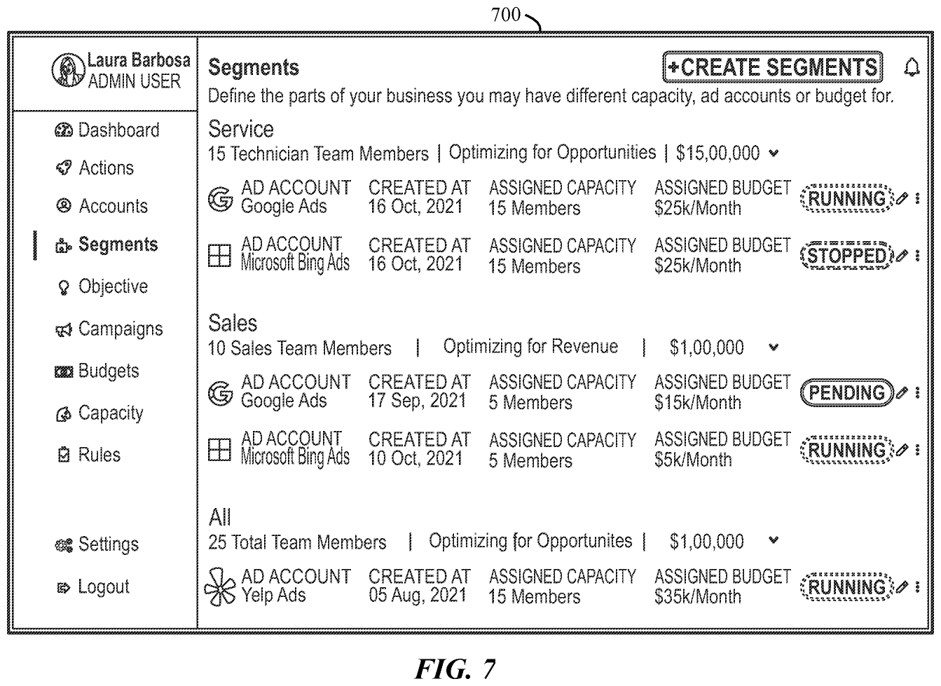

FIG. 7 illustrates a screenshot of the segments interface 700 including service segments, sales segments, and other segments associated with a business. The service segments may include a number of technician team members, optimizing for opportunities data, account information, capacity data, budget data, and the like. Sales segment may include team member data, revenue optimization information, and the like.

As used herein, the term “segment” and/or “segments” refers to the separation of departments (i.e., sales, service, plumbing, HVAC, etc.) within a business and their goals. Further, businesses may be segmented by region (i.e., east, west, etc.). The segment may be any type of label which differentiates individuals and groups of individuals within a business and their unique goals.

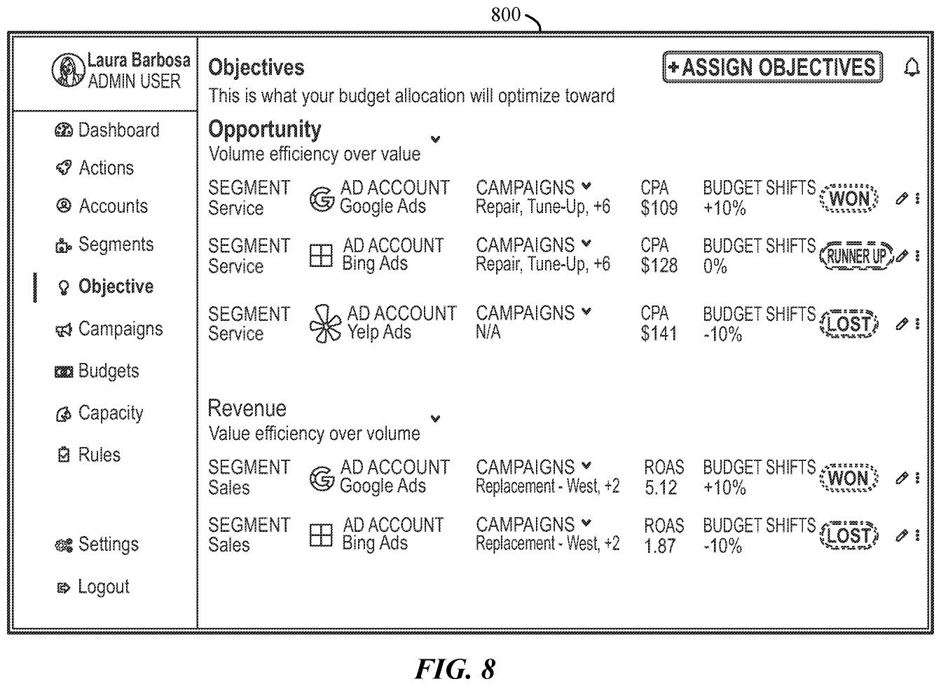

FIG. 8 illustrates a screenshot of the objectives interface 800 wherein objectives and opportunities are provided to the user. The opportunities portion 810 and revenue portion 820 includes various segments, campaigns, and other parameters which are provided to the user to aid in budget calibration and allocation. As used herein, the term “objectives” is used to define goals for each segment.

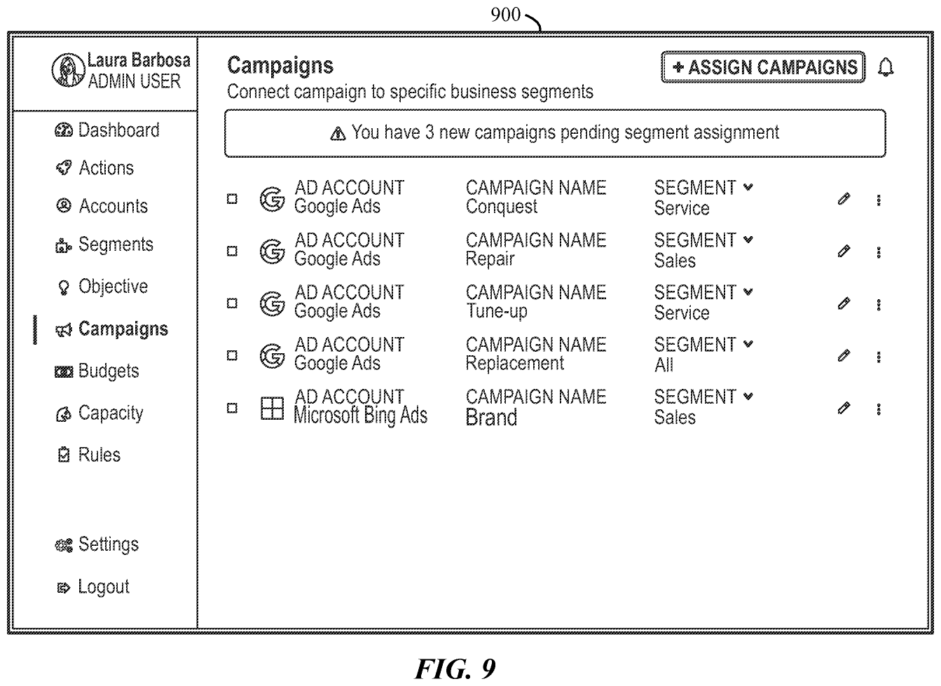

FIG. 9 illustrates a screenshot of the campaigns interface 900, wherein campaign information is displayed to the user. The campaign interface 900 includes account information, campaign information, segment information, and the like. Campaigns are assigned to each advertising platform for different regions or departments (e.g., segment). The campaign interface 900 allows users to define which campaign belongs to a particular segment or group of segments.

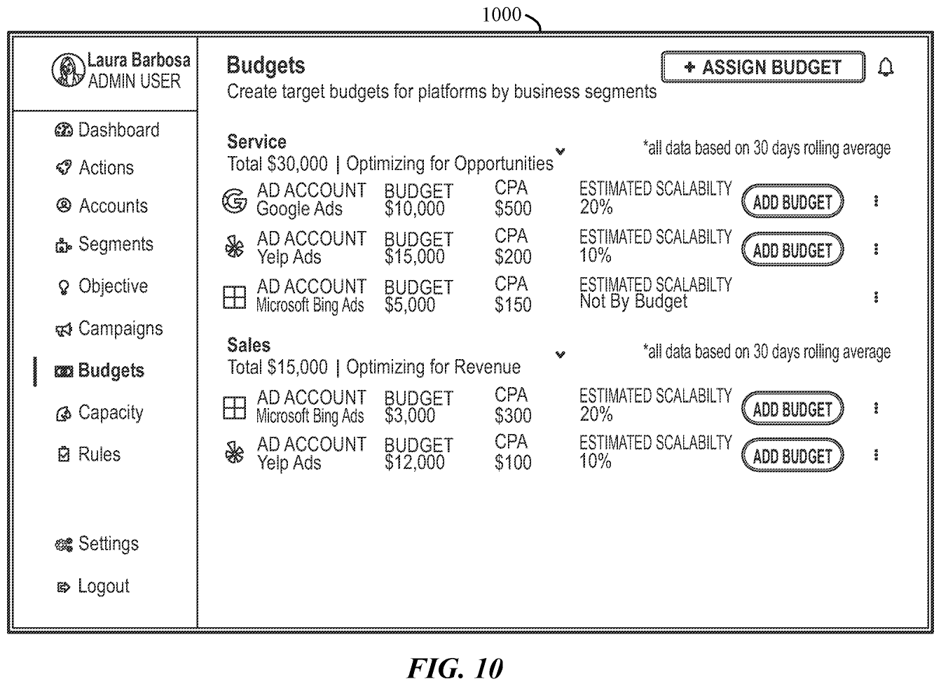

FIG. 10 illustrates a screenshot of the budgets interface 1000 wherein budget data is disclosed. The budgets interface 1000 allows for the selection of a budget for each of a plurality of segments. The budget may adjust automatically over time between advertising channels and between days.

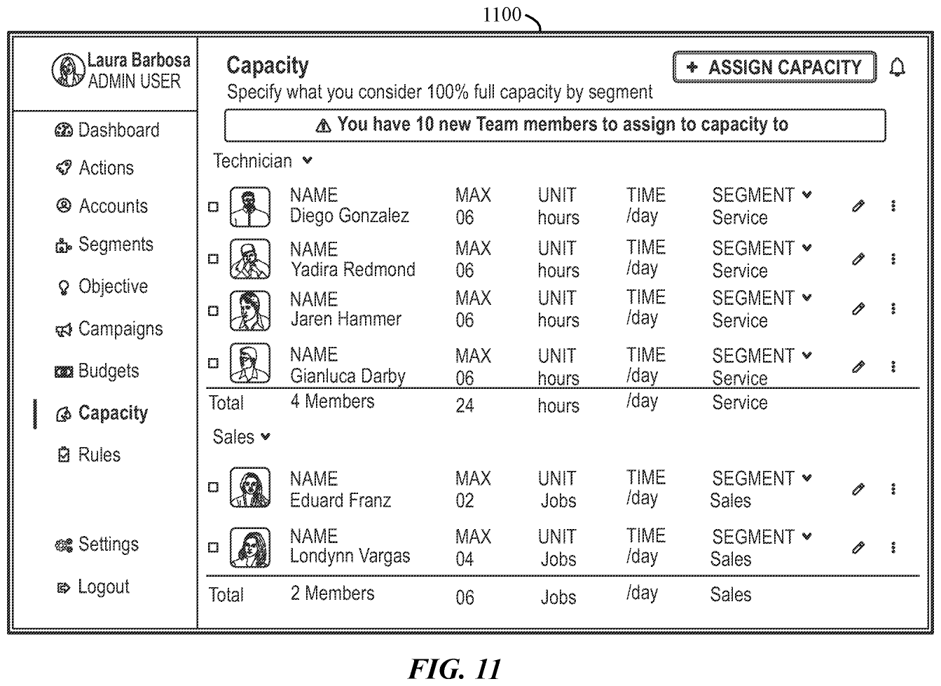

FIG. 11 illustrates a screenshot of the capacity interface 1100 wherein capacity information is disclosed including current projects and bandwidth for a particular user. For example, the capacity interface 1100 includes maximum time or resources which may be allocated, type of service, etc. The capacity interface 1100 includes employee and pipeline information which is used to define a capacity for each segment. Capacity may vary depending on the particular individual, the segment they belong to, and other factors. In such, a single users capacity may differ from another's (e.g., 100% capacity for user 1 is 3 appointments per day, while 100% capacity for user 2 is 6 appointments per day).

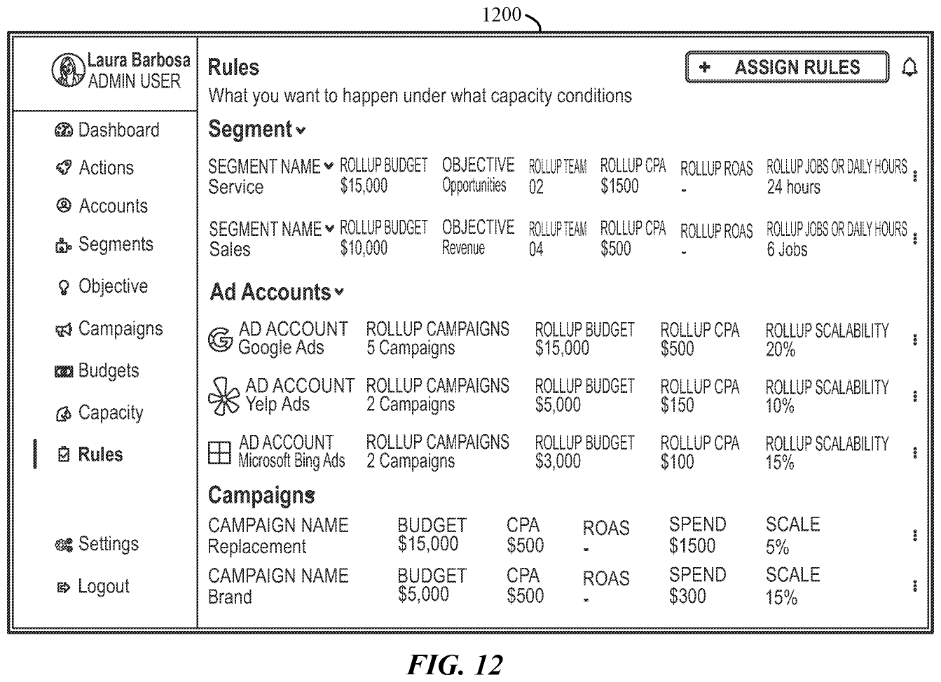

FIG. 12 illustrates a screenshot of the rules interface 1200, wherein the user establishes rules utilized by the system to efficiently schedule, adjust the budget, and perform the various other features of the system.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for conditional advertising budget calibration and allocation, the system comprising:
at least one user computing device in operable connection with a network;
an application server in operable communication with the user network, the application server configured to host an application program for providing a system for advertising budget calibration and allocation, the application program having a user interface module for providing access to the application program through the user computing device; and
a machine learning engine for receiving a plurality data from an employee and capacity database configured to store employee capacity information and determining a bandwidth for one or more employees to allocate a budget.

2. The system of claim 1, further comprising a campaigns and budgets database to store a plurality of user-input budget information.

3. The system of claim 2, wherein the machine learning engine inputs a plurality of budget information to the campaigns and budget database.

4. The system of claim 1, further comprising a segment database to store a plurality of business segment information.

5. The system of claim 1, further comprising a budget rules database to store a plurality of user-input budget rules.

6. The system of claim 1, further comprising a CRM module to communicate with a CRM system.

7. The system of claim 1, further comprising a budget module to establish a budget corresponding to the one or more employees.

8. The system of claim 7, wherein the budget corresponds to availability of the one or more employees to determine a budget for each of the one or more employees.

9. A method for conditional advertising budget calibration and allocation, the method comprising the steps of:
connecting an application program to one or more advertisement platforms;
displaying a campaign within the one or more advertisement platforms;
displaying one or more employees within a CRM system;
determining if the one or more employees are within or outside a capacity threshold;
connecting a CRM system and an advertisement platform via a segment;
defining, via a user, at least one rule in context of a goal, wherein the rules are defined by the segment to adjust a budget or a bid within campaigns.

10. The method of claim 9, further comprising a campaigns and budgets database to store a plurality of user-input budget information.

11. The method of claim 10, wherein the machine learning engine inputs a plurality of budget information to the campaigns and budget database.

12. The method of claim 11, further comprising a segment database to store a plurality of business segment information.

13. The method of claim 12, further comprising a budget rules database to store a plurality of user-input budget rules.

14. The method of claim 13, further comprising a CRM module to communicate with a CRM system.

15. The method of claim 14, further comprising a budget module to establish a budget corresponding to the one or more employees.

16. The method of claim 15, wherein the budget corresponds to availability of the one or more employees to determine a budget for each of the one or more employees.

17. The method of claim 16, further comprising the step of the system logging subsequent changes for review and refinement.
